(19) United States
(12) Patent Application Publication
(10) Pub. No.: US 2010/0093412 A1
(43) Pub. Date: Apr. 15, 2010

(54) PROTECTIVE ENVELOPE FOR A HANDHELD ELECTRONIC DEVICE

(75) Inventors: Didier-Michel SERRA, Redwood City, CA (US); Charles Stanley WALTON, Marshfield, MA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: INSIDE CONTACTLESS, Aix en Provence (FR)

(21) Appl. No.: 12/248,201

(22) Filed: Oct. 9, 2008

(51) Int. Cl. H04M 1/00

(52) U.S. Cl. 455/575.8

(57) ABSTRACT

A protective envelope for a handheld electronic device is shaped to cover at least 40% of a surface of the handheld device. The protective envelope includes at least a first housing having at least one first host processor or being suitable for receiving at least one first host processor, at least one main antenna, and an assembly for linking the host processor to the main antenna.

### BACKGROUND OF THE INVENTION

Embodiments of the present invention relate to a protective envelope for a handheld electronic device, such as a mobile telephone, a personal digital assistant, or an MP3 player.

Embodiments of the present invention more particularly relate to radio-frequency identification (RFID) techniques and Near Field Communication (NFC) techniques.

Recently, the industry has greatly invested in research and development in order to integrate NFC technology in wide-spread handheld electronic devices, beginning with mobile telephones. Mobile telephone manufacturers are already proposing new generations of NFC mobile telephones that offer, in addition to the customary mobile telephone functions, NFC functions (such as, for example, the mobile telephone 6131 NFC commercially available from NOKIA®).

The NFC techniques offer a short-range communication distance, typically from several millimeters to tens of centimeters, and are utilized in combination with conventional RFID techniques in order to make electronic chips capable of exchanging data with contactless chip cards, contactless electronic tags, or other NFC chips by inductive coupling.

As a result, an NFC mobile telephone can typically read data in contactless RFID tags or cards, or communicate with other NFC devices. NFC technology also allows transactions to be performed, such as the payment of services (transportation, bills, or the like), the withdrawal of money, the purchase of units, or the like. An NFC telephone can thus be used as a means of payment similar to a credit card.

FIG. 1 schematically represents the architecture of a mobile phone 10 equipped with an NFC communication assembly. The telephone 10 conventionally includes a base-band processor BBP, a Subscriber Identification Module SIM inserted in a housing of the telephone 10 and having a processor P1, and various circuits and controls (keyboard, display, or the like), schematically shown as a shaded block 11. The NFC communication assembly of the mobile telephone 10 includes an NFC controller, designated by the reference NFCC, and an antenna circuit having an antenna coil ACI with one or more windings.

In order to offer the user access to payment services, a secure element SE having a processor P2 is also provided. This processor P2 can be embedded in the telephone 10 or supplied in a removable microcard format that can be inserted in a slot or a housing of the telephone 10. In a standard NFC chipset architecture for mobile telephones, processors BBP, P1, and P2 are considered as host processors of the controller NFCC (See, for example, patent applications EP 1 855 229 and EP 1 855 389 or US 2007/0263595 and US 2007/0263596 to Inside Contactless). Data routing between these various elements is performed by the controller NFCC according to a Host Controller Interface (HCI) protocol.

In spite of these recent technical developments, the main hindrance to the development of NFC technology in mobile telephones is the market itself, that is to say the user demand, as well as the number of NFC applications currently available. In broad terms, the “commercial equation” that needs to be solved in order to allow for a rapid development of NFC technology is to lower the price of NFC mobile telephones (ideally an NFC mobile telephone should be sold at the same price as that of a conventional mobile telephone) while increasing the number of applications available to the users. However, one does not occur without the other: a greater number of applications would encourage more users to acquire NFC mobile telephones, from which a drop in price would result due to mass-production. Inversely, an increasing number of users with NFC mobile telephones would encourage service-providers to offer a greater number of NFC applications. As these two parameters of the “commercial equation” are interdependent, it is understandable that the decrease in cost of embedded NFC technology is an essential factor for its development.

From this point of view, the hardware integration of NFC controllers into existing NFC mobile telephone platforms is an obstacle to the development of NFC technology and causes an increase in the cost of the platform that is greater than the cost of the NFC controller itself. In fact, such integration requires modifications of the motherboard architecture of the telephone and modifications of the architecture of the other elements (in particular for their adaptation to the HCI interface).

It is desirable to promote NFC technology by proposing a simple solution that allows mobile telephone users to benefit from NFC technology and its applications without requiring that the mobile telephone manufacturers redesign the hardware architecture of their mobile telephones.

### BRIEF SUMMARY OF THE INVENTION

Embodiments of the invention relate to a protective envelope for a handheld electronic device, shaped to cover at least 40% of the surface of the handheld device, and including at least a first housing having at least one first host processor or being suitable for receiving at least one first host processor, at least one main antenna, and a link between the host processor and the main antenna.

In one embodiment, the link between the processor and the main antenna is internal wiring.

In one embodiment, the link between the processor and the antenna is an auxiliary antenna connected to the host processor, which is inductively coupled with the main antenna.

In one embodiment, the first housing is shaped to receive a plastic card, in which the host processor is embedded.

In one embodiment, the protective envelope further includes a contactless communication controller or a second housing suitable for receiving the main communication controller, and a link between the contactless communication controller and the main antenna.

In one embodiment, the first housing includes a first group of contacts to contact the host processor. The contactless communication controller is linked to the antenna through internal wiring, and the contactless communication controller is linked to contacts of the first group of contacts through internal wiring, so that the host processor is linked to the main antenna through the contactless communication controller.

In one embodiment, the contactless communication controller is linked to the antenna through internal wiring, and the main antenna is configured to be inductively coupled with an auxiliary antenna of the host processor.

In one embodiment, the protective envelope includes a second housing to accommodate the contactless communication controller. The first housing includes a first group of contacts to contact the host processor. The second housing includes a second group of contacts to contact the contactless communication controller. Contacts of the second group of contacts are connected to the main antenna through internal wiring, and contacts of the first group of contacts are linked to contacts of the second group of contacts through internal wiring, so that the host processor is linked to the main antenna through the contactless communication controller.

In one embodiment, the protective envelope further includes at least one connector configured to be connected to the handheld electronic device, and an internal electric wiring and contacts to link the contactless communication chip to the connector.

In one embodiment, the protective envelope further includes at least one wireless interface circuit linked to the contactless communication controller and configured to establish a wireless link between the contactless communication controller and the handheld device.

In one embodiment, the protective envelope further includes at least one power supply source such as an electric battery, a solar cell, or both.

In one embodiment, the protective envelope further includes internal electric wiring having conductors formed on one side of an insulating material, forming the body of the envelope or embedded in the insulating material.

In one embodiment, the body of the envelope is made of at least one supple and flexible material.

Embodiments of the present invention also relate to a method for supplying an assembly for using a contactless communication technology to users of a handheld electronic device. The method includes supplying the users with a protective envelope for the handheld device, shaped to cover at least 40% of the surface of the handheld device, and providing, in the protective envelope: at least a first housing having at least one first host processor or being suitable for receiving at least one first host processor, and at least one main antenna, linked to the host processor of inductively coupled to an auxiliary antenna of the host processor.

In one embodiment, the method further includes providing users with an NFC contactless chip embedded in a plastic microcard to be inserted in the first housing.

In one embodiment, the method further includes: providing, in the protective envelope, a contactless communication controller embedded in the protective envelope or a second housing to receive a contactless communication controller, and electric wiring to link the contactless communication controller to the main antenna. The method further includes providing users with the auxiliary secure chip embedded in a plastic microcard, to allow users to conduct transactions involving debiting a user account.

In one embodiment, the method further includes providing, in the protective envelope, at least one connector to be connected to the handheld device.

In one embodiment, the method further includes providing, in the protective envelope, a wireless interface circuit linked configured to establish a wireless link between with the handled device.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows schematically the conventional architecture of an NFC mobile telephone;

FIGS. 2A, 2B are front views of a first embodiment of a protective envelope according to the invention;

FIG. 3 is a rear view of the protective envelope of FIGS. 2A and 2B;

FIGS. 4A and 4B show rear and front views of an example of an electronic component to be inserted into the protective envelope;

FIG. 5 shows the electric architecture of the protective envelope of FIG. 3 when equipped with the electronic components of FIGS. 4A, 4B and connected to the mobile telephone;

FIG. 6 is a rear view of a second embodiment of a protective envelope according to the invention;

FIG. 7 is a rear view of a third embodiment of a protective envelope according to the invention;

FIG. 8 shows the electric architecture of the protective envelope of FIG. 7;

FIGS. 9A and 9B are rear and front views of embodiments of a protective envelope according to the invention;

FIG. 10 shows the electric architecture of a fourth embodiment of a protective envelope according to the invention;

FIG. 11 shows applications of the protective envelope; and

FIGS. 12 and 13 are rear views of fifth and sixth embodiments of a protective envelope according to the invention.

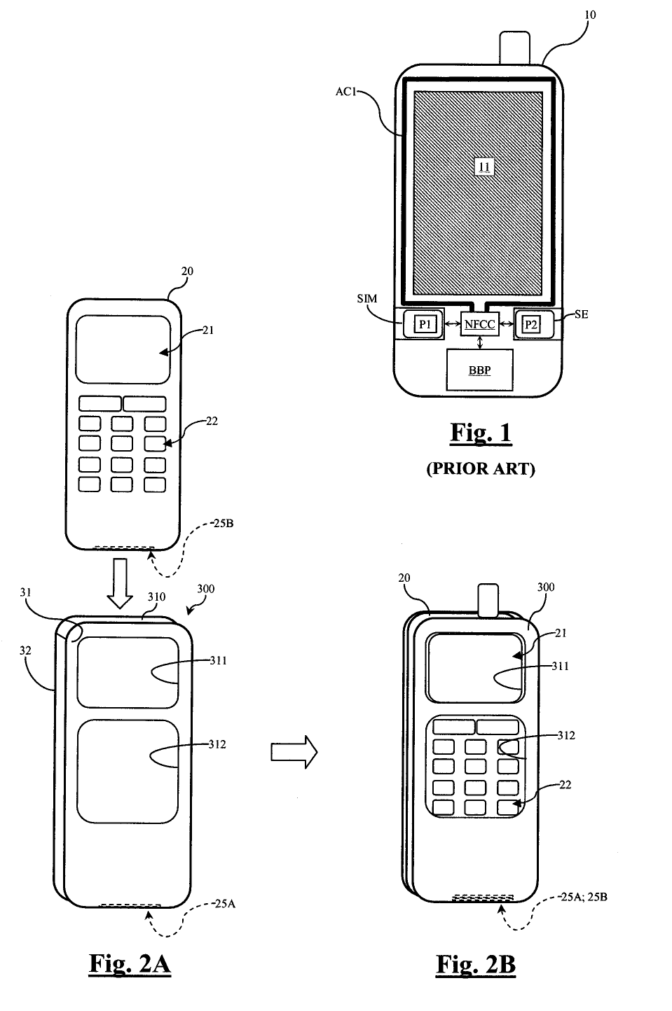

### DETAILED DESCRIPTION OF THE INVENTION

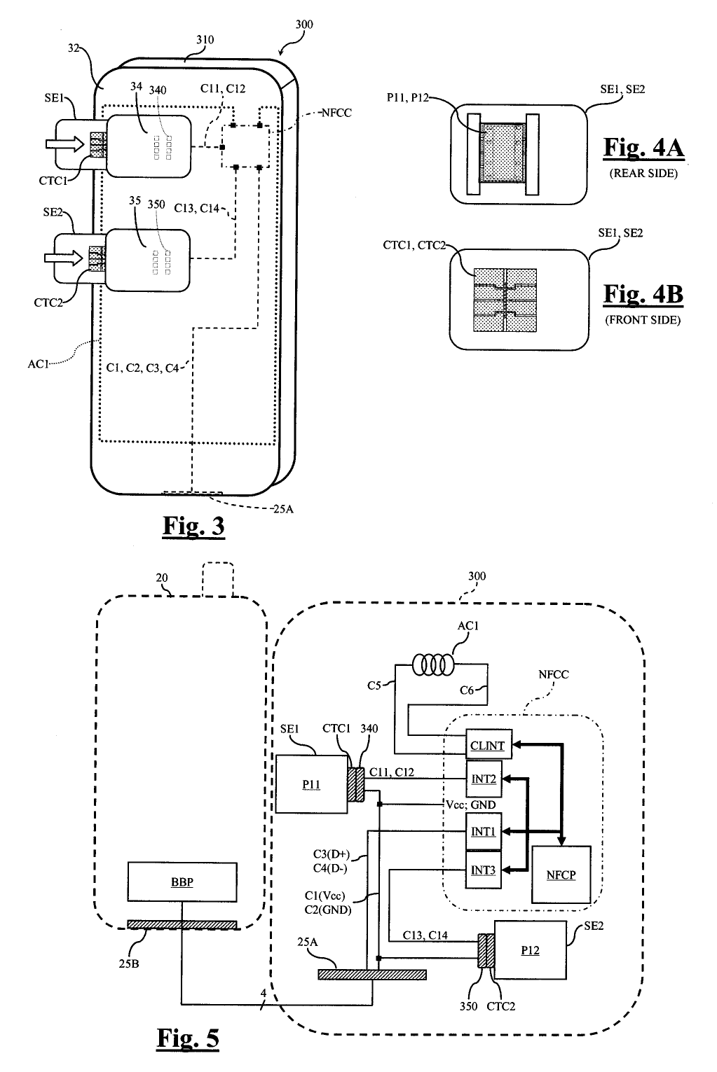

FIGS. 2A, 2B, and 3 show an embodiment 300 of a protective envelope according to the invention, designed to accommodate a mobile telephone 20. The protective envelope includes a front side 31 (FIGS. 2A, 2B), a rear side 32 (FIG. 3) and covers at least 40% of the telephone surface. An opening 310 is provided between the front side and the rear side so that the telephone 20 may be inserted into the envelope 300, as shown in FIGS. 2A, 2B. The front side 31 additionally includes an opening 311 allowing access to a screen 21 of the telephone 20 and an opening 312 allowing access to a keypad 22 of the telephone 20. The openings 311, 312 may be covered with a thin transparent material if protection against rain is desired. Other openings can be provided, such as to allow access to telephone buttons and/or connectors. In some embodiments, a single opening may be provided on the front side to accommodate a telephone without a keypad, equipped with a touch screen.

The protective envelope 300 also includes a male or female connector 25A provided for connection with a respective female or male connector 25B of the mobile telephone 20 when inserted into the protective envelope 300. For example, the connector 25A is a male USB connector and the connector 25B is a female USB connector.

As shown in FIG. 3, the protective envelope 300 also includes, located on or in its rear side 32, a controller NFCC, and an antenna coil AC1 having one or more windings. The controller NFCC is in the form of a semiconductor chip and is connected to the antenna coil AC1. Both are shown through the material of the envelope 300 in FIG. 3.

The controller NFCC's architecture is, for example, similar to the architecture of an NFC controller commercialized by Inside Contactless under the designation Microread®, and integrates an NFC reader function (active mode) and an NFC card emulation function (passive mode). The controller NFCC can operate under various different contactless protocols, such as ISO 14443 A/B, 15693, 18092, or the like. The protective envelope 300 also includes one or more housings to receive other components, here two housings 34, 35. Each housing 34, 35 comprises an insertion slot suitable for receiving a plastic microcard, respectively SE1, SE2, that may have a conventional format such as Micro-SIM, Plug-in SIM or ID-000, and may be detached from an ISO ID-1 card by the user the first time it is used.

Each microcard SE1, SE2 is of “secure element” type and is provided to secure some types of transactions. For example, microcard SE1 is provided by a first application provider and microcard SE2 is provided by a second application provider.

Referring to FIG. 4A, showing the rear side of the microcards, each microcard SE1, SE2 includes a secure processor P11, P12, respectively, in the form of a semiconductor chip embedded in the microcard, which is shown in FIG. 4A through the material of the microcard. As shown in FIG. 4B, the front side of each microcard SE1, SE2 is provided with a group of contacts CTC1, CTC2, respectively, connected to corresponding inputs/outputs of the processor P11, P12.

Referring again to FIG. 3, each housing 34, 35 is also equipped with a group of contacts 340, 350 that are shown through the material of protective envelope. Each contact of the group of contacts 340, 350 is arranged in order to connect with a contact of the group of contacts CTC1, CTC2 of the microcards SE1, SE2, when inserted into the housings 34, 35. The protective envelope 300 also comprises various electrical conductors C1 to C6, C11, C12, C13, C14 that allow for realizing an interconnection pattern shown in FIG. 5.

FIG. 5 shows the electrical diagram of the protective envelope when it is connected to the telephone 20 via the connectors 25A, 25B and when microcards SE1, SE2 are inserted in the respective housings 34, 35. It is assumed in this examplary embodiment that connectors 25A, 25B are of USB type and comprise terminals Vcc (power supply), GND (ground), D+ and D− (data signals). Conductors C1 to C4 are connected to terminals of the connector 25A. Conductor C1 conveys the supply voltage Vcc, conductor C2 conveys the ground potential GND, conductor C3 conveys data signal D+, and conductor C4 conveys data signal D−. The controller NFCC is connected to conductors C1-C6, C11-C14. The processors P11, P12 are connected to conductors C1(Vcc) and C2(GND) through contacts of the groups of contacts CTC1, CTC2, respectively, and contacts of the groups of contacts 340, 350, respectively. The controller NFCC and the processors P11, P12 are in this manner electrically powered by the mobile telephone through the connectors 25A, 25B. Conductors C11, C12 are also linked to inputs/outputs of processor P11 through contacts of the group of contacts 340 and contacts of the group of contacts CTC1. Conductors C13, C14 are also linked to inputs/outputs of processor P12 through contacts of the group of contacts 350 and contacts of the group of contacts CTC2. In this manner, the controller NFCC is linked to the processor P11 through conductors C11, C12 and to the processor P12 through conductors C13, C14 and can exchange data with the latter.

In one embodiment, processors P11 and P12 may be powered by power supply terminals of the controller NFCC, instead of being connected to the Vcc/GND lines of the USB bus.

An examplary architecture of the controller NFCC is also shown in FIG. 5. The controller NFCC includes a processor NFCP, three interface circuits INT1, INT2, INT3, and a contactless interface circuit CLINT. Interface circuits INT1-INT3, CLINT are linked to the processor NFCP through internal data and address buses. The interface circuit CLINT is connected to the antenna coil AC1 through conductors C5, C6. Interface circuit CLINT includes modulation and demodulation circuits, as well as antenna circuit components, for example, tuning capacitors. In some embodiments, one of the conductors C5, C6 may also form the antenna coil AC1 itself by having extensions forming one or more inductive windings.

The interface INT1 is a USB interface circuit and is linked to the processor BBP of the mobile telephone through conductors C3(D+), C4(D−) and connectors 25A, 25B. In this manner, the controller NFCC can exchange data with the baseband processor BBP. The interface circuits INT2, INT3 are, for example, serial communication circuits such as Universal Asynchronous Receiver Transmitters (UARTs) or any other type of communication interface conventionally implemented in NFC controllers, such as single wire protocol (SWP), S2C (SigIn SigOut), ISO 7816, or the like. The interface INT2 is connected to conductors C11, C12, which are linked to the processor P11. The interface INT3 is connected to conductors C11, C12 which are linked to the processor P12. In this manner, the controller NFCC can exchange data with processors P11, P12.

The group of elements includes the controller NFCC, the processors P11, P12, and the baseband processor BBP, interconnected in the previously-described manner, forms the equivalent of an NFC chipset of the type described in applications EP 1 855 229 and EP 1 855 389, or US 2007/263595 and US 2007/263596, in which P11, P12 are host processors of controller NFCC. Thus, when a contactless communication link has been established between controller NFCC and an external secured device, one of the host processors P11, P12 can manage a secure transaction with the secure external device through the controller NFCC. However, such a “chipset” is implemented here without it being necessary to integrate the controller NFCC and the host processors P11, P12 on the motherboard of the mobile telephone.

The material forming the body of protective envelope 300 can be an electrically insulating material that is either single-layer or multilayer. It is preferably supple and flexible, but may also be rigid in applications in which a stronger protection is desired. Conductors C1-C6, C11-C14 are, for example, conductive tracks deposited on the material forming the protective envelope or sandwiched between two layers of this material or of different materials. Likewise, the controller NFCC chip may be mounted on the material forming the protective envelope or sandwiched between two layers of this material or of different materials. In one embodiment, the material forming the protective envelope is very thin and the protective envelope forms a sort of “smart skin” that covers the telephone.

A magnetic screen, for example a magnetically-reflective layer comprising a magnetically-conductive material, can also be provided on, or in, the protective envelope to protect the circuitry of the telephone from the magnetic field emitted by the antenna coil AC1.

FIG. 6 shows an embodiment 301 of the protective envelope which differs from that of FIG. 3 in that controller NFCC is no longer embedded in the envelope and in that a housing 33 is provided to receive the controller NFCC. The housing 33 includes an insertion slot, which includes a group of contacts 330 that are shown in FIG. 6 through the material of the protective envelope. The processor NFCC is embedded in a microcard NFCCARD, the front side of which comprises a group of contacts CTC3 which are connected to inputs/outputs of the controller NFCC. The controller NFCC is linked to conductors C1-C6 and C11-C14 through contacts of the group of contacts CTC3 and contacts of the group of contacts 330.

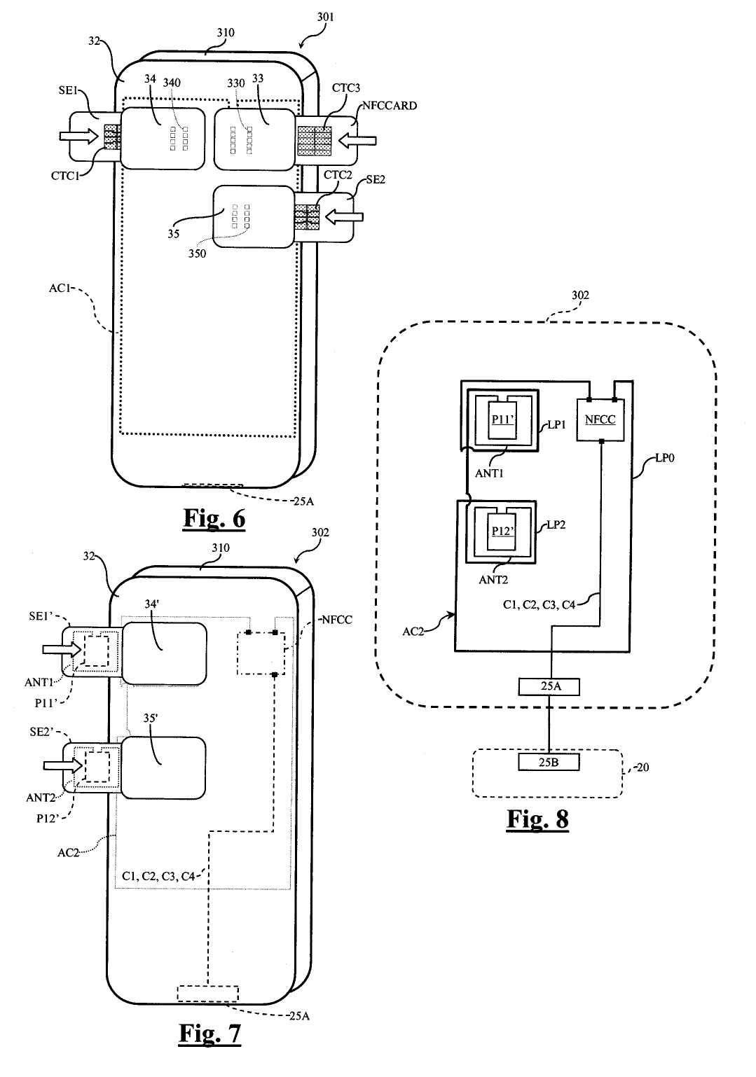

FIG. 7 shows an embodiment 302 of the protective envelope which differs from that of FIG. 3 in that the protective envelope comprises housings 34′, 35′ without groups of contacts provided to accommodate contactless microcard SE1′, SE2′ respectively. Conductors C11 to C14 are also not present inside the envelope. Each microcard SE1′, SE2′ comprises, embedded therein, an auxiliary antenna coil ANT1, ANT2 instead of the groups of contacts CTC1, CTC2 and a processor P11′, P12′ connected to the auxiliary antenna coil ANT1, ANT2, respectively. Auxiliary antenna coils ANT1, ANT2 are schematically represented and may comprise one or more windings. In addition, antenna coil AC1 is replaced by an antenna coil AC2 which is designed to be inductively coupled with the auxiliary antenna coils ANT1, ANT2. Each processor P11′, P12′ is a contactless integrated circuit for example such as that commercialized by Inside Contactless under the designation Micropass®, which is generally embedded in contactless chip cards.

FIG. 8 shows the electrical diagram of the protective envelope 302. The antenna AC2 comprises a main loop LP0 and two auxiliary loops LP1, LP2 in series. Loops LP0, LP1, LP2 are schematically represented and may include one or more windings. The auxiliary loop LP1 surrounds the area where the microcard SE1′ is located (i.e., the location defined by the housing 34′) so as to be inductively coupled with the auxiliary antenna coil ANT1 of the microcard SE1′. The auxiliary loop LP2 surrounds the area where the microcard SE2′ is located (defined by the housing 35′) so as to be inductively coupled with auxiliary antenna coil ANT2 of the microcard SE2′. Thanks to this arrangement, the controller NFCC can exchange data with an external NFC component by inductive coupling of antenna AC2 with the antenna coil of the external component; exchange data with processor P11′ of microcard SE1′ by inductive coupling of AC2 (loop LP1) with antenna coil ANT1; exchange data with processor P12′ of microcard SE2′ by inductive coupling of AC2 (loop LP2) with antenna coil ANT2; and exchange data with the mobile telephone 20 through connector 25A and conductors C1 to C4.

Processors P11′, P12′ may also be configured to perform NFC transactions. In that case, the protective envelope 302 can also be used in a passive mode in which an external NFC reader or NFC controller establishes a communication with one of processors P11′, P12′ to implement a transaction. Antenna coil AC2, which is inductively coupled to auxiliary antenna coils ANT1 ANT2, is therefore used by processor P11′ or P12′ as a booster antenna during the transaction, to increase the communication distance with the external NFC reader or NFC controller. Once the transaction is completed, the controller NFCC may ask processors P11′ or P12′ to forward to it the transaction data or a transaction summary.

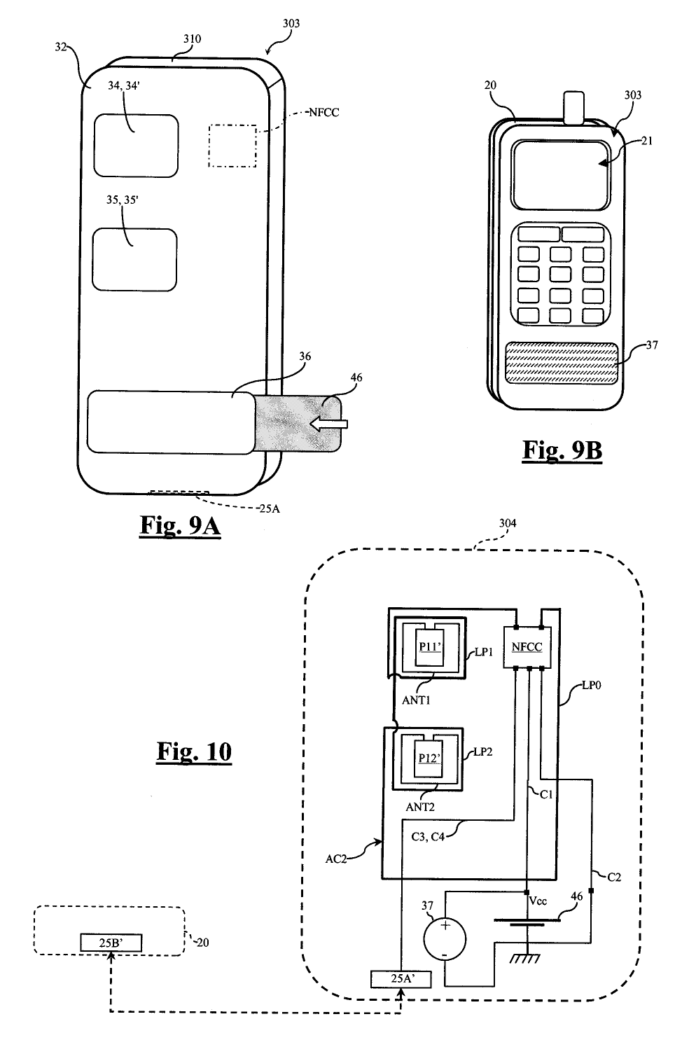

Additionally, as shown in FIG. 9A, an embodiment 303 of the protective envelope can comprise a housing 36 to accommodate an electric battery 46, and corresponding contacts (not shown) to bring a power supply Vcc, provided by the battery, to the components in the protective envelope. As shown in FIG. 9B, the protective envelope 303 can also includes a power supply source 37, such as solar cells.

In another variant of the protective envelope, connector 25A is replaced by a wireless data link with the mobile phone. As an example, FIG. 10 is an electrical diagram of an embodiment 304 of the protective envelope which differs from that of FIG. 8 in that the protective envelope is powered by both the battery 46 and the solar cells 37. In addition, the connector 25A is replaced by a wireless Bluetooth® interface circuit 25A′, which is configured to establish a communication with a wireless Bluetooth® interface 25B′ of the mobile phone 20 upon request of the controller NFCC.

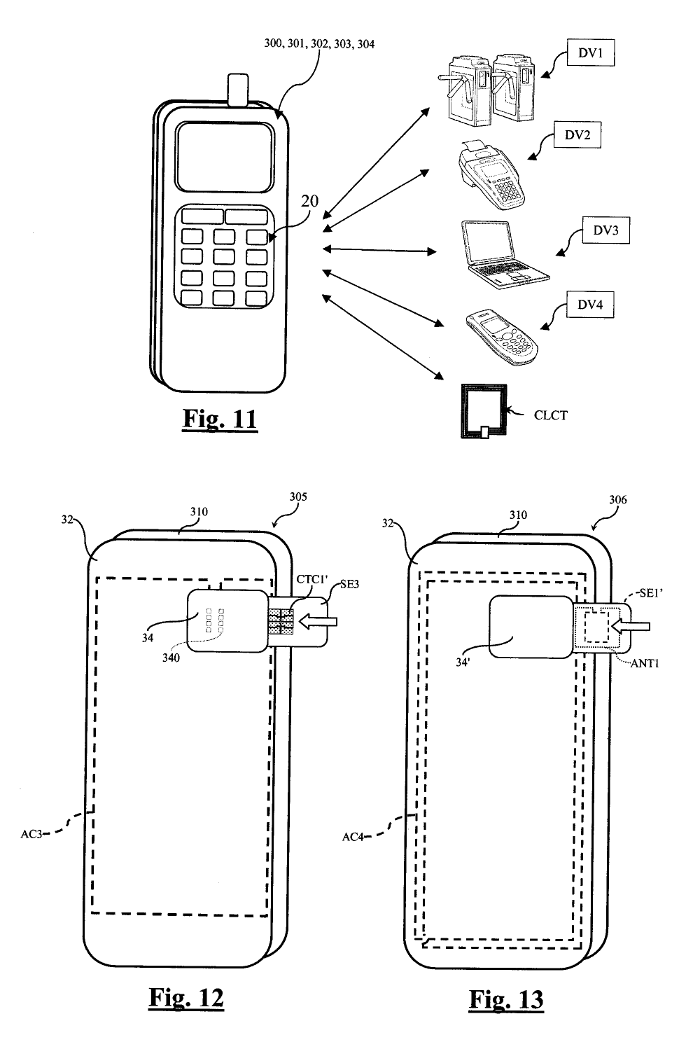

FIG. 11 shows application examples of the mobile telephone 20 equipped with the protective envelope 300, 301, 302, 303, 304 and at least one secure microcard SE1, SE1′, SE2 or SE2′ supplied by a service provider. The secure microcard allows a user account to be debited for access to services where payment is required. The telephone with the protective envelope 300-304 offers the same NFC functionalities as an NFC telephone. It can exchange data by inductive coupling with external NFC devices and makes possible, for example, (i) the payment of transport access by performing an NFC transaction with a payment terminal DV1; (ii) the payment of a service or a bill (restaurant, gas station, etc.) by performing a transaction with a payment terminal DV2; (iii) the exchange of data with another NFC device such as a microcomputer DV3 equipped with an NFC interface or an NFC telephone DV4; and (iv) the reading or the writing of data in an electronic tags CLCT, or the like

Various other embodiments of a protective envelope according to embodiments of the invention can be contemplated by those skilled in the art. Various other host processors may be provided to offer additional functionalities or contactless services. Likewise, additional housings may be provided to receive memory cards comprising NFC application software or memory cards to save transaction data.

Embodiments of the protective envelope may also be provided to be used as a passive “smart skin” and may comprise one or more contactless integrated circuits without the controller NFCC. By way of example, FIG. 12 shows an embodiment 305 in which the protective envelope only comprises the previously described housing 34, the group of contacts 340, and an antenna coil AC3 comprising one or more windings. Terminals of the antenna coil AC3 are connected to contacts of the group of contacts 340. A secure element SE3 in the form of a microcard is inserted in the housing 34. The secure element SE3 comprises, embedded therein, a contactless processor in the form of a semiconductor chip (not shown) and a group of contacts CTC1′ linked to inputs/outputs of the contactless processor. When the secure element SE3 is inserted in the housing 34, the processor is connected to antenna coil AC3 and an external NFC reader or an NFC controller can perform transactions with the processor by inductive coupling.

Another example of passive “smart skin” 306 is shown in FIG. 13. The protective envelope only includes an antenna coil AC4 and the previously-described housing 34′. The secure element SE1′, with its antenna coil ANT1, is inserted in the housing 34′. The antenna coil surrounds the area of the antenna coil ANT1 (i.e. the location defined by the housing 34′) and behaves like a booster antenna to increase the communication distance between an external NFC reader or an NFC controller and the secure element SE1′.

In other respects, instead of being equipped with an NFC controller communication chip using a B-field antenna coil and inductive coupling techniques to communicate with external NFC devices, embodiments of the protective envelope according to the invention may comprise UHF communication chips. In this case an E-field antenna, such as a dipolar antenna or a petal-shaped antenna, is provided instead of the B-field antenna coil.

Finally, a protective envelope according to embodiments of the invention can also be configured to be used with various other types of handheld electronic devices such as personal digital assistants (PDAs), MP3 players, or the like.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A protective envelope for a handheld electronic device, shaped to cover at least 40% of a surface of the handheld device and comprising:
at least a first housing having at least one first host processor or being configured to receive at least one first host processor;
at least one main antenna; and
a link between the host processor and the main antenna.

2. A protective envelope according to claim 1, wherein the link between the processor and the main antenna comprises internal wiring.

3. A protective envelope according to claim 1, wherein the link between the processor and the antenna comprises an auxiliary antenna connected to the host processor, which is inductively coupled with the main antenna.

4. A protective envelope according to claim 1, wherein the at least first housing is shaped to receive a plastic card in which the first host processor is embedded.

5. A protective envelope according to claim 1, further comprising:
a contactless communication controller or a second housing suitable for receiving the main communication controller; and
a link between the contactless communication controller and the main antenna.

6. A protective envelope according to claim 5, wherein:
the first housing comprises a first group of contacts to contact the host processor;
the contactless communication controller is linked to the antenna through internal wiring; and
the contactless communication controller is linked to contacts of the first group of contacts through internal wiring, so that the host processor is linked to the main antenna through the contactless communication controller.

7. A protective envelope according to claim 5, wherein: the contactless communication controller is linked to the antenna through internal wiring, and the main antenna is configured to be inductively coupled with an auxiliary antenna of the host processor.

8. A protective envelope according to claim 5, comprising a second housing to accommodate the contactless communication controller, and wherein:
the first housing comprises a first group of contacts to contact the host processor, the second housing comprises a second group of contacts to contact the contactless communication controller, contacts of the second group of contacts being connected to the main antenna through internal wiring, and
contacts of the first group of contact are linked to contacts of the second group of contacts through internal wiring, so that the host processor is linked to the main antenna through the contactless communication controller.

9. A protective envelope according to claim 5, further comprising:
at least one connector configured to be connected to the handheld electronic device, and
an internal electric wiring and contacts to couple the contactless communication chip to the connector.

10. A protective envelope according to claim 5, further comprising at least one wireless interface circuit coupled to the contactless communication controller, and configured to establish a wireless connection between the contactless communication controller and the handheld device.

11. A protective envelope according to claim 1, further comprising at least one power supply source, the power supply being one of an electric battery, a solar cell, or both.

12. A protective envelope according to claim 1, further comprising internal electric wiring comprising conductors, the conductors being formed on one side of an insulating material forming the body of the envelope or embedded in the insulating material.

13. A protective envelope according to 1, wherein a body of the envelope is made of at least one supple and flexible material.

14. A method for supplying an assembly for using a contactless communication technology to users of a handheld electronic device, the method comprising:
supplying the users with a protective envelope for the handheld device, the protective envelope being shaped to cover at least 40% of a surface of the handheld device, and
providing, in the protective envelope:
at least a first housing, the first housing comprising at least one first host processor or being suitable for receiving at least one first host processor, and
at least one main antenna, linked to the host processor and being inductively coupled to an auxiliary antenna of the host processor.

15. A method according to claim 14, further comprising providing users with an NFC contactless chip embedded in a plastic microcard to be inserted in the at least first housing.

16. A method according to claim 14, further comprising:
providing, in the protective envelope:
a contactless communication controller embedded in the protective envelope or a second housing configured to receive a contactless communication controller, and
electric wiring to couple the contactless communication controller to the main antenna, and
providing users with the auxiliary secure chip embedded in a plastic microcard, to allow users to conduct transactions involving debiting a user account.

17. A method according to claim 14, further comprising providing in the protective envelope at least one connector to be connected to the handheld device.

18. A method according to claim 14, further comprising providing in the protective envelope a wireless interface circuit configured to establish a wireless link with the handheld device.
